(19) United States
(12) Patent Application Publication
(10) Pub. No.: US 2019/0065217 A1
(43) Pub. Date: Feb. 28, 2019

(54) SYSTEM AND METHOD FOR CREATING, DISTRIBUTING & RENDERING PROGRESSIVE WEB APPLICATIONS

(71) Applicant: APPY PIE LLC, Warrenton, VA (US)

(72) Inventors: Abhinav GIRDHAR, Warrenton, VA (US); Gaurav SRIVASTAVA, Warrenton, VA (US); Subhash RAWAT, Warrenton, VA (US)

(21) Appl. No.: 15/881,557

(22) Filed: Jan. 26, 2018

Related U.S. Application Data
(60) Provisional application No. 62/549,825, filed on Aug. 24, 2017.

(51) Int. Cl. G06F 9/445; G06F 8/34; G06F 8/61; G06F 8/65

(52) U.S. Cl. CPC G06F 9/44505; G06F 8/65; G06F 8/61; G06F 8/34

(57) ABSTRACT

A system for creating, distributing and rendering a Progressive Web Application (PWA) content on a home screen of a mobile device is provided. The system includes an interface configured for enabling creation of one or more PWAs. The system includes a remote server configured for hosting the created one or more PWAs. Further, the system includes a browser based configuring application residing on the mobile device, wherein the mobile device comprises a processor configured for performing the steps of providing a browser interface, to a user for accessing one or more PWAs, receiving instructions from the user of the mobile device, to configure the PWA on the home screen of the mobile device, communicating one or more parameters associated with the PWA to an application programming interface (API) for configuring the PWA on the home screen of the mobile device and rendering the content of the PWA on the mobile device.

This application claims priority to U.S. Provisional Application Ser. No. 62/549,825 filed on Aug. 24, 2017, incorporated herein by reference.

### FIELD OF TECHNOLOGY

This disclosure relates generally to Progressive Web Applications (PWA) and more particularly to system and methods for creating, distributing and rendering content of Progressive Web Apps (PWAs) on a home screen of a mobile device.

### BACKGROUND

Progressive Web App (PWA) is a term used to denote web applications (apps) having capabilities to deliver a ‘mobile app’ like user experience. PWA are technically regular web pages (or websites) but can appear like traditional applications or (native) mobile applications to a user on the home screen of a mobile device. The Progressive Web Applications attempts to combine features offered by most modem browsers with the benefits of mobile experience.

Typically, the user can access any particular website using a browser present on the mobile device. PWAs offer an easier way to access the websites or webpages of interest on the mobile device in a manner similar to that of accessing native applications on the mobile device. Existing methods for accessing PWAs require the user to perform certain steps manually in order to create a ‘native application’ like icon on the home screen of the mobile device. Further, existing methods for creation, automatic installation or configuration of any website or any Progressive Web App on the mobile device are cumbersome and there exists a need for automating the process of installation.

Further, owing to faster acceptance of PWAs by mobile device users over native applications, there is a need for a distribution platform that allows developers or publishers of PWAs to distribute, manage, upgrade and monetize from the distribution of PWAs across different mobile device platforms. There also exists a need for a browser for automatic and instantaneous configuration of PWAs on mobile devices. Existing browsers are not compatible to allow new PWAs to be installed instantaneously on the mobile device and offer limited support to native applications only.

### SUMMARY

In order to solve at least some of the above mentioned problems, there exists a need for a system and a method for creating, accessing, distributing and monetizing PWAs across different mobile device platforms.

This summary is provided to introduce a selection of concepts in simple manners that are further described in the detailed description of the disclosure. This summary is not intended to identify key or essential inventive concepts of the subject matter nor is it intended to determine the scope of the disclosure.

Briefly, according to an exemplary embodiment, a system for rendering a Progressive Web Application (PWA) content on a home screen of a mobile device is provided. The system includes an interface configured for enabling creation of one or more PWAs. The system includes a remote server configured for hosting the created one or more PWAs. Further, the system also includes a browser based configuring application residing on the mobile device, wherein the mobile device comprises a processor with a memory, wherein the processor is configured for performing the steps of providing a browser interface, to a user for accessing the one or more PWAs, receiving instructions from the user of the mobile device, to configure the PWA on the home screen of the mobile device, communicating one or more parameters associated with the PWA to an application programming interface (API) for configuring the PWA on the home screen of the mobile device and rendering the content of the PWA upon receiving instructions from the user of the mobile device on the PWA.

Briefly, according to an exemplary embodiment, a method for rendering a Progressive Web Application (PWA) content on a home screen of a mobile device is provided. The method includes creating, one or more PWAs using an interface. The method includes hosting the created one or more PWAs on a remote server. Further, the method also includes providing a browser interface, to a user for accessing one or more PWAs. The method also includes receiving instructions from the user of the mobile device, to configure the PWA on the home screen of the mobile device. In addition, the method also includes communicating one or more parameters associated with the PWA to an application programming interface for configuring the PWA on the home screen of the mobile device and rendering the content of the PWA upon receiving instructions from the user of the mobile device on the PWA.

The summary above is illustrative only and is not intended to be in any way limiting. Further aspects, exemplary embodiments, and features will become apparent by reference to the drawings and the following detailed description.

### BRIEF DESCRIPTION OF THE FIGURES

These and other features, aspects, and advantages of the exemplary embodiments can be better understood when the following detailed description is read with reference to the accompanying drawings in which like characters represent like parts throughout the drawings, wherein:

FIG. 1 is a block diagram of one embodiment of a system configured for creating, distributing and rendering content of one or more Progressive Web Apps (PWA) on a home screen of a mobile device, according to an embodiment of the present disclosure;

FIG. 2 is a flow chart illustrating a method for creating, distributing and rendering content of one or more Progressive Web Apps (PWA) on a home screen of a mobile device, according to an embodiment of the present disclosure;

FIGS. 3A and 3B illustrate several example mobile screens depicting the process flow for creating, distributing and rendering a Progressive Web Application (PWA) content using mobile devices native browser on a home screen of a mobile device from a remote server, according an example embodiment of the present disclosure; and

FIG. 4 is a block diagram of a computing device utilized for implementing the system of FIG. 1 according to an embodiment of the present disclosure.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having the benefit of the description herein.

### DETAILED DESCRIPTION

For the purpose of promoting an understanding of the principles of the invention, reference will now be made to the embodiments illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not comprise only those steps but may comprise other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

At least one exemplary embodiment is generally directed towards creating, distributing and rendering of content associated with a Progressive Web Application (PWA), on a home screen of a mobile device. In one embodiment, a system and a method is disclosed that is configured for rendering content of one or more Progressive Web Apps (PWA) on the home screen of the mobile device, by creating and configuring an interactive icon of the PWA on the home screen of the mobile device. As a result, when a user of the mobile device taps or clicks on the interactive icon configured on the home screen of the mobile device, the content of the PWA is rendered to the user of the mobile device.

The word Progressive Web Application, Progressive Web Applications, Progressive Web Apps, PWAs and PWA generally relate to the class of applications installable on mobile devices that can render the websites or webpages in a traditional/native mobile application format instantly. PWAs offer advantages of both the websites and native applications, in that the content of PWAs is updated instantly similar to websites or webpages, and the content is readily accessible on the mobile device in a manner similar to that of native applications. The terms Progressive Web Application and PWA are used interchangeably in the description.

In addition to the illustrative aspects, exemplary embodiments, and features described above, further aspects, exemplary embodiments of the present disclosure will become apparent by reference to the drawings and the following detailed description.

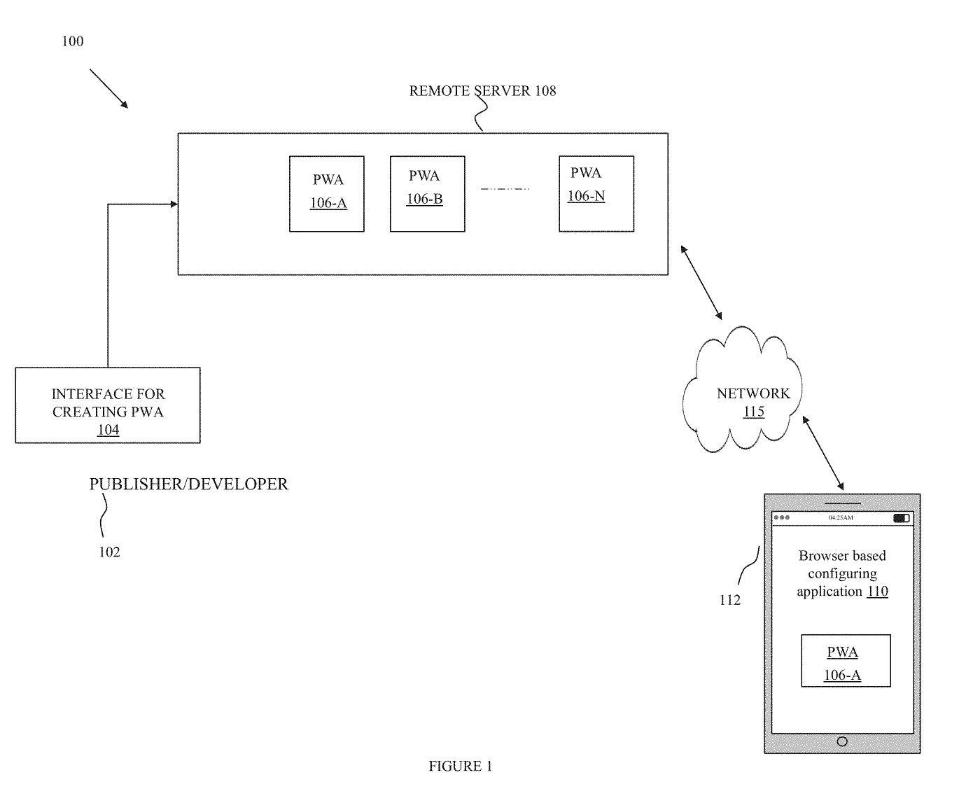

FIG. 1 is a block diagram of one embodiment of a system 100 configured for creating, distributing and rendering content of one or more Progressive Web Apps (PWA) on a home screen of a mobile device, according to an embodiment of the present disclosure. In particular, the system 100 includes an interface 104 for creation of PWAs, a remote server 108, a network 115 and a mobile device 112.

Progressive Web Apps (PWA) have evolved to bridge the gap between websites and mobile apps. PWAs are known to utilize modem web capabilities to deliver an app-like user experience including an offline mode, push notifications, splash screens, and animated page transitions. In one embodiment, one or more Progressive Web Applications (PWA) can be created using an interface 104 of an App (Application) builder tool. For example, the interface 104 may be utilized by a publisher or a developer 102 for creation of the PWA. The interface 104 is the same as the one used for creation of one or more native mobile applications. The App builder tool may be a third party platform that enables or allows a developer/publisher 102 to create one or more native mobile applications or the PWAs. In one embodiment, the interface 104 may provide the developer/publisher 102 several options, such as pre-designed templates, customizations, etc. for creating the PWA.

In one embodiment, the interface 104 may enable the developer/publisher 102 to create PWA for a specific mobile OS or may provide an option to turn a website or a webpage into a PWA. Further, the interface 104 may provide several features and options for customizing the PWA, such as ‘Business App builder’, ‘Animation App builder’, ‘recipe App builder’, ‘Fitness Tracker app builder’ and the like. The process of creating PWA using the interface 104 provided by the App builder tool does not require any programming knowledge, codes, scripts and the like. In one example, the App builder tool or a third party platform may be App Builder (for example Appy Pie™) utilized by the developers 102 for creating Android and iPhone Apps.

Furthermore, the one or more created PWAs (106-A through 106-N) are hosted on the cloud or the remote server 108. In one embodiment, the PWAs (106) created by the publishers/developers 102 through a third party platform or an ‘app’ generation service or the App builder tool can be accessed by users directly through a URL or via a PWA distribution platform, which acts as an interface between the users and an entity hosting the PWAs (106). Such created PWAs (106) are accessible through the PWA distribution platform and are available to a vast audience conveniently. In one embodiment, the PWA distribution platform is a cloud based platform. The PWA distribution platform is configured for distribution, management and versioning of the one or more PWAs hosted on the platform.

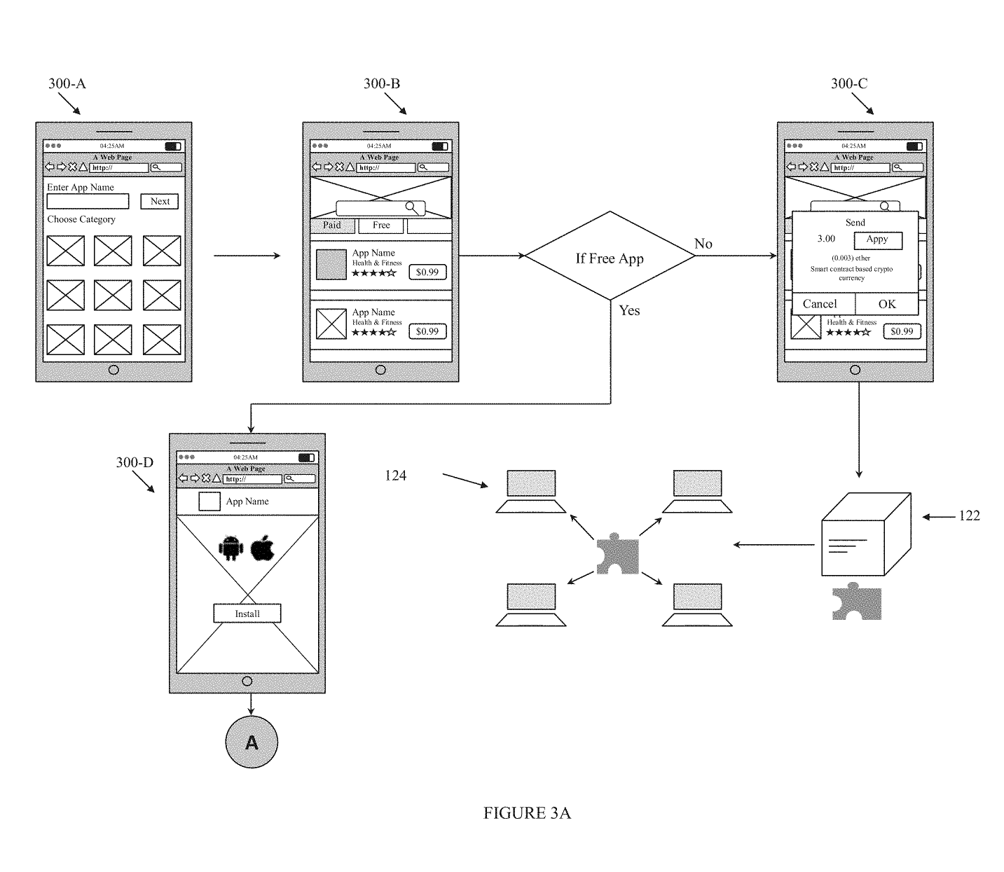

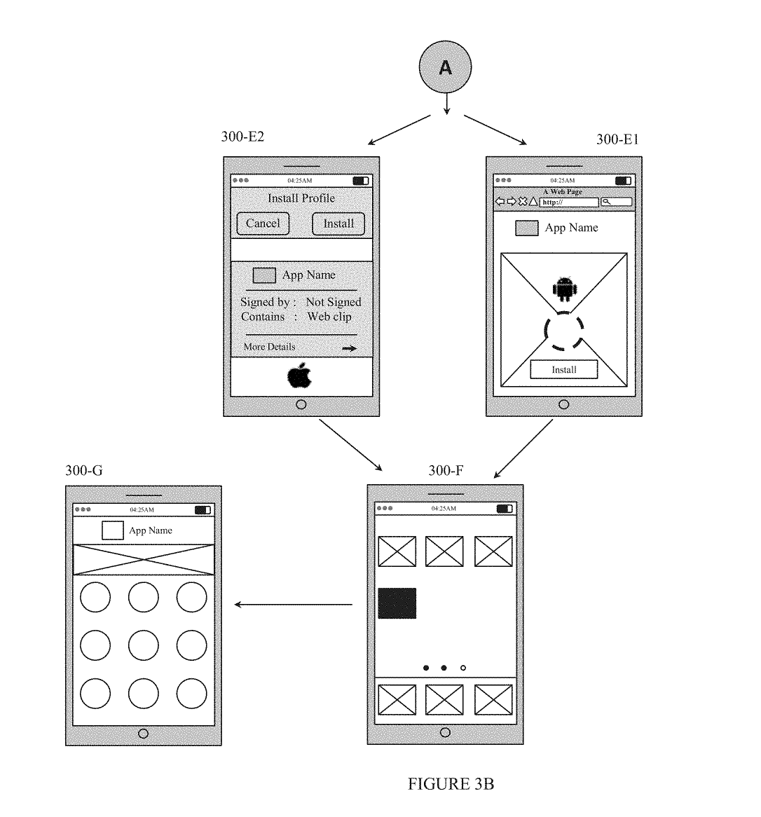

In one embodiment, the one or more PWAs hosted on the cloud or the remote server 108 are made available for distribution to various mobile devices across different geographies via the PWA distribution platform. The PWA distribution platform of the present disclosure enables developers and publishers to monetize the PWAs. In one embodiment, the PWA distribution platform provides an interface to the user of the mobile device 112 for purchasing the PWAs using different payment modes including but not limited to cryptocurrency. Specifically, the PWA distribution platform manages distribution and monetization of the PWAs by creating a smart contract for each PWA download request received from the mobile device 112. The event of generation of smart contract (122 as shown in FIG. 3) is then broadcasted to a network of computing devices (124 as shown in FIG. 3) for a predefined time period, once the plurality of such events for one or more PWAs is verified on the network of computing devices, each of the plurality of such events is entered into a distributed ledger which is maintained across the network of computing devices (124) including the remote server 108, thereby completing the PWA purchase and download verification process.

In another embodiment, a similar process of generating smart contracts and verifying the events of creating smart contracts is carried out by the PWA distribution platform for handling transactions with developers and publishers of PWA.

Moreover, the one or more PWA (106) created and hosted on the remote server 108 can be configured on the home screen of the mobile device 112 in a single step, with a single click. For example, when the user accesses the PWA distribution platform for installing PWA 106-A using a browser (browser interface) present on the mobile device 112, a browser based configuring application 110 provides an option to the user via the install button (as shown on the screen 300-D in FIG. 3) to add one or more PWAs (106-A) on the home screen of the mobile device 112. The browser based configuring application 110 causes automatic installation and configuration of the selected PWA on the home screen of the mobile device 112 upon receiving user instructions, thereby eliminating a plurality of manual steps to add the PWA on the home screen of the mobile device 112, as known in the art. The automatic installation or configuration of any website or any Progressive Web App (PWA) on the home screen of the mobile device 112 is triggered by user instructions received by way of click or tap on the ‘install’ button. The configuration of the PWA facilitates rendering of the content associated with the installed one or more Progressive Web Apps (PWAs) on the home screen of the mobile device 112.

In one embodiment, the browser based configuring application 110 resides on the mobile device 112. The processor of the mobile device 112 is configured for executing the configuration component of the browser based configuring application 110. The user interface for the browser based configuring application 110 (browser interface) provides an install button to the user (as shown on the screen 300-D in FIG. 3) that configures the PWA (106-A) on the home screen of mobile device 112. The configuration component of the browser based configuring application 110 runs the installation script to configure the PWA on the home screen of the mobile device 112.

In one embodiment, the configuration component of the browser based configuring application 110 extracts one or more of an icon, name and URL of the selected PWA 106-A, upon receiving user instructions for installation and communicates the extracted information to an application programming interface (API) of the mobile OS running on the mobile device 112. Upon receiving the extracted information associated with the selected PWA by the API, an “Add to Home Screen” service (for Android mobile OS) or a similar service for other mobile OS is executed, thereby configuring the selected PWA, i.e. PWA 106-A on the home screen of the mobile device 112.

Further, the configuration of the PWA 106-A on the home screen of the mobile device 112 facilitates rendering of the content of the PWA via the browser of the mobile device 112. For example, a PWA for a news website regularly visited by the user of the mobile device 112 is first installed on the home screen of the mobile device 112 as described in various embodiments of the present disclosure. Upon successful installation and configuration, an interactive icon for the news PWA is created on the home screen of the mobile device 112, such that tapping or clicking on the interactive icon causes the PWA to fetch the content, i.e. the news content from a remote resource and render the content on the browser of the mobile device 112. It is to be noted that the browser based configuring component 110 is configured to customize the content being rendered on the browser, so as to provide an experience similar to that of a native application. One or more customizations include but are not limited to hiding or disabling the various features native to the browsers, hiding address bars, tool bars etc.

Further, the browser based configuring application 110 is configured for versioning of the one or more PWAs installed on the home screen of the mobile device 112. In one embodiment, the browser based configuring application 110 receives updates for the one or more PWAs from a remote server, PWA distribution platform and the like. Similar to the process of configuration and installation, the browser based configuring application 110 transmits the updates to the service APIs of the mobile OS, in order to install or upgrade the installed PWAs. In another embodiment, the browser based configuring application 110 continuously polls the remote server or the PWA distribution platform, such that whenever an update for a PWA is released by a developer/publisher, the update is fetched by the browser based configuring application 110 residing on the browser of the mobile device 112.

In another embodiment, the browser based configuring application 110 is configured for sending push notifications for each of the one or more PWAs installed on the mobile device 112. For each of the one or more PWAs installed on the mobile device, the browser based configuring application manages the settings, versioning, provides an interface with the mobile OS and exchanges information with the remote server and/or PWA distribution platform.

In some other embodiments, a manner or a method in which the content associated with the PWA 106-A is rendered on the home screen of the mobile device 112 is described in detail below.

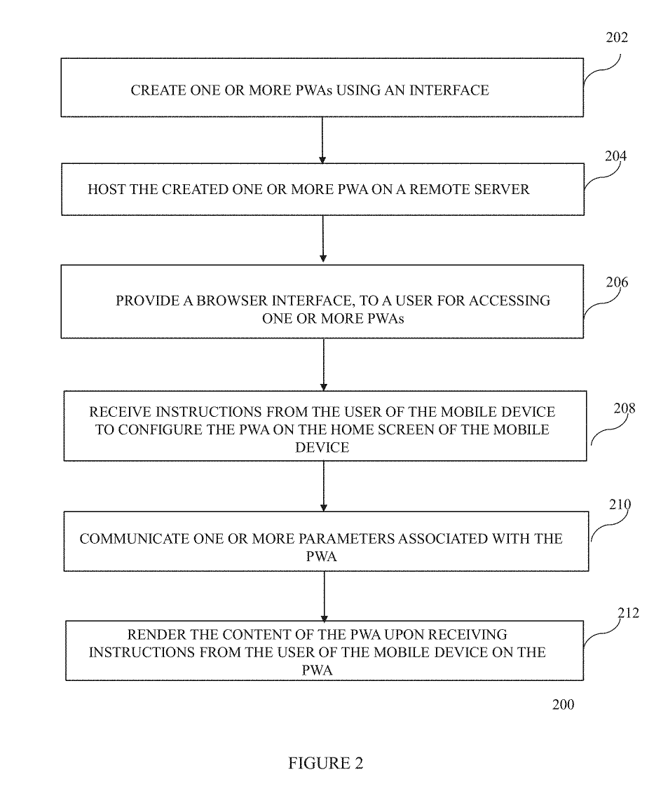

FIG. 2 is a flow chart illustrating a method 200 for creating, distributing and rendering content associated with a Progressive Web Application (PWA) on a home screen of a mobile device, according to an embodiment of the present disclosure. FIG. 2 may be described from the perspective of a processor that is configured to execute computer-readable instructions to carry out the functionalities of the browser based configuring application 110, configuration component, remote server 108, and interface 104 of the system 100 of FIG. 1. In particular, the steps as described in FIG. 2 may be executed for creating, distributing and rendering content associated with a Progressive Web Application (PWA) on the home screen of the mobile device from the remote server 108. Each step is described in detail below.

At step 202, one or more PWAs are created using an interface 104. In one embodiment, one or more Progressive Web Applications (PWA) can be created using an interface 104 of an App (Application) builder tool. For example, the interface 104 used by a publisher or a developer 102 for creation of the PWAs is the same as that used for creation of native mobile applications. The App builder tool may be a third party platform that enables or allows a developer/publisher 102 to create one or more native mobile applications or the PWAs and release the PWAs on one or more PWA distribution platforms. In one embodiment, the interface 104 provides the developer/publisher 102 several options for customizing the PWAs.

At step 204, the one or more created PWAs (106-A through 106-N) are hosted on the cloud or remote server 108. At step 206, a browser interface is provided to a user for accessing one or more PWAs. In one embodiment, the user accesses one or more PWAs (106) for installation on the home screen of the mobile device by browsing through the PWA distribution platform on the browser interface. In another embodiment, the one or more PWAs (106) are accessed by users directly through a URL provided by the developers or publishers of the one or more PWAs (106). It is to be noted that the PWA distribution platform of the present disclosure performs one or more of distribution, management, versioning and monetization of one or more PWAs hosted on the cloud or remote server 108.

At step 208, after browsing the one or more PWAs displayed on the browsing interface of the mobile device 112, instructions are received from the user of the mobile device 112, to configure the PWA (106) on the home screen of the mobile device 112. For example, when the user opens, accesses the PWA distribution platform (PWA store) for PWAs (106) using a browser interface present on the mobile device 112, the browser based configuring application 110 provides an option to the user via the install button (as shown on the screen 300-D) to add one or more PWAs on the home screen of the mobile device 112. The browser based configuring application 110 comprises a configuration component configured for rendering the content of the one or more PWA on the home screen of the mobile device 112.

Upon receiving user instructions by way of click or tap on the browser interface of the mobile device 112, the browser based configuring application 110 fetches one or more parameters associated with the selected one or more PWAs.

At step 210, the one or more parameters associated with the PWA are communicated to an application programming interface (API) of the mobile device 112 for configuring the PWA on the home screen of the mobile device 112. The one or more parameters associated with the PWA comprise an icon, name and Uniform Resource Locator (URL) of the selected PWA. In one embodiment, the browser based configuring application 110 communicates the URL, name and an icon associated with the selected PWA to an API of the mobile device 112. Further an ‘Add to home screen’ service or Web Clip Method’ (based on the mobile OS) of the mobile device 112 is executed, thereby creating an interactive icon of the PWA on the home screen of the mobile device 112 instantaneously.

At step 212, upon receiving user instructions to access the now installed PWA, the content of the PWA is rendered to the user through the browser interface of the mobile device 112. The user instructions are, for example, in the form of touch or tap or click on the interactive icon of the PWA. In one embodiment, the browser based configuring application 110, upon receiving instructions on the interactive icon of the installed PWA, fetches the content of the PWA from the cloud or the remote server 108 and renders the content on the browser interface of the mobile device 112. In one embodiment, the browser based configuration application 110 customizes the content or the browser interface or both, for rendering the content of the PWA in a non-intrusive manner. For example, the browser based configuration application 110, performs one or more of hiding the address bar of the browser interface, hiding the footer, tool bar of the browser interface, enabling content zooming and the like, so as to provide an experience similar to that of a native mobile application.

It is to be noted that the process 200 for creating, distributing & rendering progressive web application (PWA) content through the browsing interface or a third party browser application of the mobile device leads to reduced data consumption and memory usage by the mobile device 112 as compared to native mobile applications. Since PWAs are very light applications and require minimal interference from user (by using the method 200 or the system 100), the overall data consumption is reduced. Moreover, the process 200 facilitates instant loading with service worker scripts. In one embodiment, the distribution of PWA's is on a 256 bit secure certificate (Valid secure HTTPS connection), thereby improving security.

In one embodiment, the process of installation and downloading of the PWA (106) from the remote server (108) involves a secure connection, the main thrust of this requirement is primarily to add an additional security layer, in order to prevent any malware. Further, having a secure connection also contributes to create trust among users.

The aforementioned system and method for rendering a Progressive Web Application (PWA) content on a home screen of a mobile device from a remote server, is now explained using example interfaces. Some of the relevant interfaces are described in further detail below. It is noted that the present technique is by no means intended to be limited to these example embodiments.

FIG. 3A illustrates several example mobile screens 300-A through 300-I depicting the process flow for creating, distributing and rendering progressive web application (PWA) content using mobile devices native browser, on a home screen of a mobile device from a remote server, according an example embodiment of the present disclosure.

Referring to screen 300-A, one or more Progressive Web Applications (PWA) can be created using an interface of an App (Application) builder tool. For example, the App builder tool may be used by a publisher or a developer for creating one or more PWAs. The App builder tool may be a third party platform that enables or allows a developer/publisher to create one or more native mobile applications or the PWA. In one embodiment, the App builder tool may provide the developer/publisher several options for customizing one or more PWAs. For example, the App builder tool may enable the developer or the publisher to create PWAs for specific mobile OS or may provide an option to turn his/her website site into a PWA. Further, the App builder tool may provide several features and options such as ‘Business App builder’, Animation App builder, recipe App builder, Fitness Tracker app builder and the like. The process of creating PWA using the interface provided by the App builder tool is very simple and user friendly. In one example, the App builder tool or a third party platform may be App Builder (for example Appy Pie) utilized by the developers for creating Android and iPhone Apps.

Referring to screen 300-B, the one or more created PWAs are hosted on the cloud. In one embodiment, the PWAs created by the publishers/developers through a third party platform or an ‘app’ generation service or the App builder tool can be accessed by users directly through a URL or via a PWA distribution platform, such as a PWA store or marketplace, which acts as an interface between the users and an entity hosting the PWAs. Such created PWAs are accessible through the marketplace and are available to a vast audience conveniently. The PWA distribution platform performs one or more of distribution, management, versioning and monetization of PWAs.

In one example embodiment, the PWA distribution platform or the marketplace provides a list of featured PWAs. The featured list of PWAs are presented to the viewer in a categorized form. For example, the PWA on the marketplace are categorized into broad categories such as education, worship, sports, business, restaurants, fitness and several others.

The step as illustrated in the screen 300-C is an additional step and is performed by the PWA distribution platform for monetization of PWAs. The term ‘monetization’ as described herein refers to charging a payment for installation of one or more PWAs and paying a fee to the developers or publishers for the installed PWAs. The PWA distribution platform provides various payment modes to the user for making a transaction. In one embodiment, the PWA distribution platform creates a smart contract for each PWA download request received from the mobile device 112. The event of generation of smart contract is then broadcasted to a network of computing devices for a predefined time period, once the plurality of such events for one or more PWAs is verified on the network of computing devices, each of the plurality of such events is entered into a distributed ledger which is maintained across the network of computing devices including the remote server, thereby completing the PWA purchase and download verification process.

By way of using smart contracts, the PWA distribution platform ensures smoother operation for developers as well as users. For example, the PWA distribution platform ensures that a developer receives the fee for the installed PWAs based on user feedback and the like.

Referring now to screen 300-D, the one or more PWAs created and hosted on the marketplace can be installed/configured on the home screen of the mobile device with a single step in a single click. The screen 300-D illustrates a user interface for the browser based configuring application that configures the PWA on the home screen of the mobile device. In one embodiment, the screen 300-D illustrates a step that enables the user of the PWA to install/configure the PWA on the home screen of the mobile device. The installation of the PWA facilitates for rendering the content of one or more Progressive Web Apps (PWA) on the home screen of the mobile device.

For example, when the user opens, accesses the marketplace for PWAs using a browser present on the mobile device, the browser based configuring application provides an option to the user via the install button (as shown on the screen 300-D) to add one or more PWAs on the home screen of the mobile device. Due to the browser based configuring application, the user of the mobile device need not require to perform a plurality of steps manually to add the PWA (opened and accessed) on the home screen of the mobile device. However, automatic installation or configuration of any website or any Progressive Web App (PWA) on the home screen of the mobile device is possible using the ‘install’ button (as shown on the screen 300-D).

In one embodiment, the browser based configuring application 110 resides on the mobile device 112. The processor of the mobile device 112 is configured for executing the configuration component of the browser based configuring application. The user interface for the browser based configuring application provides an install button (as shown on the screen 300-D) that configures the PWA on the home screen of mobile device. The configuration component of the browser based configuring application runs the installation script to configure the PWA on the home screen of the mobile device. The configuration component is actually the function of the browser which communicates with a set of Application programming interface (APIs) related to the OS of the mobile device. APIs are common for all the PWA.

On clicking the install button by the user, the configuration component of the browser based configuring application transmits an icon, name & URL of the progressive web app (PWA), to the API of the mobile device 112 for example, Android mobile operating system and configures the (PWA) application on the home screen of the mobile device as shown on screen 300-El. In one example embodiment, for the iOS mobile operating system, the configuration component of the browser based configuring application utilizes the ‘Web Clip Method’ to pass the information to the browser interface as shown on screen 300-E2.

In one embodiment, the configuration of the PWA on the home screen of the mobile device facilitates rendering the content of the PWA upon receiving instructions from the user of the mobile device on the PWA. In one embodiment, the configuration component of the browser based configuring application communicates the URL, name and an icon associated with the selected PWA to an API of the mobile device. Further an ‘Add to home screen’ service or Web Clip Method’ (based on the mobile OS) of the mobile device is executed, thereby creating an interactive icon of the PWA on the home screen of the mobile device.

Referring now to screen 300-F of FIG. 3B, the PWA is now configured on the home screen of the mobile device as shown and an icon of the installed PWA is been created on the home screen of the mobile device.

Referring now to screen 300-G of FIG. 3B, the PWA is loaded when the user taps on the PWA icon. Further, when a user of the mobile device taps or clicks on the interactive icon configured on the home screen of the mobile device, the content associated with the PWA is rendered from a remote server to the user of the mobile device.

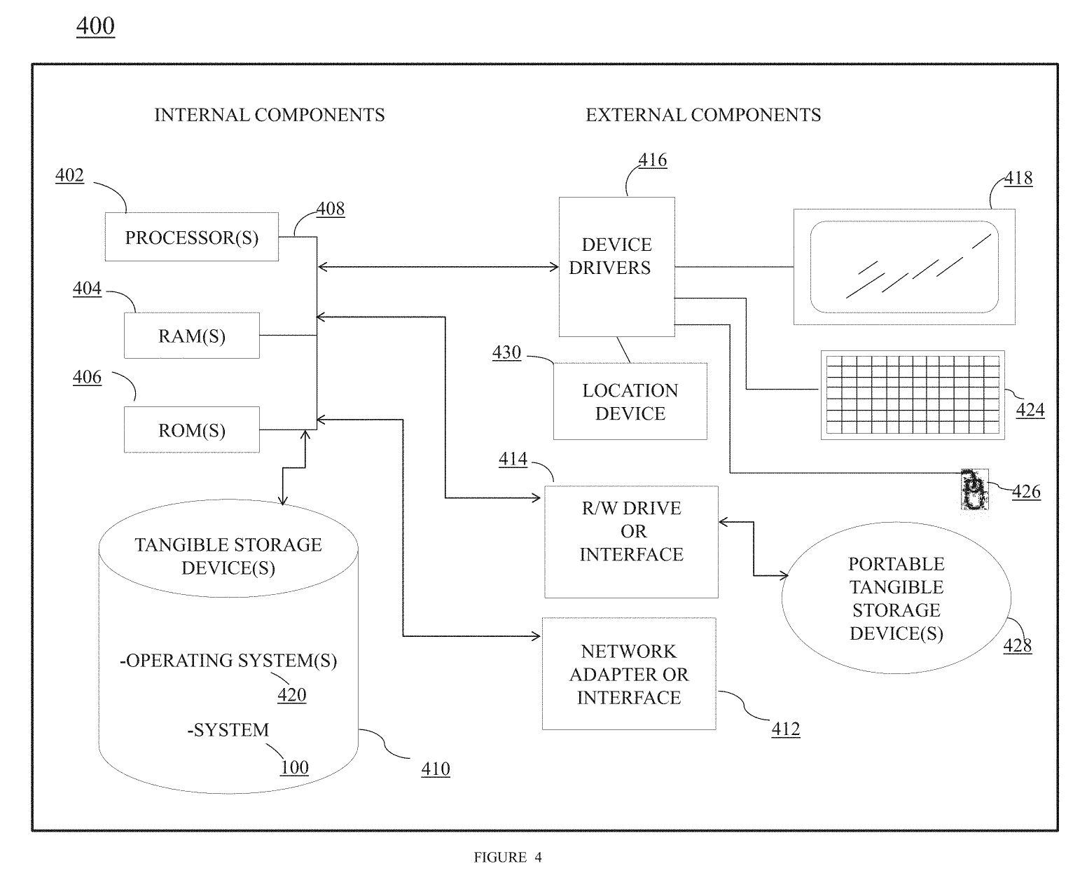

FIG. 4 is a block diagram of a computing device 400 utilized for implementing the system 100, according to an embodiment of the present disclosure. The components of the system 100 described herein are implemented in computing devices. One example of a computing device 400 is described below in FIG.4. The computing device comprises one or more processor 402, one or more computer-readable RAMs 404 and one or more computer-readable ROMs 406 on one or more buses 408. Further, computing device 400 includes a tangible storage device 410 that may be used to execute operating systems 420 and modules existing in controller 108 of system 100. The various components of the system 100 including a browser based configuring application 110, configuration component, remote server 108, and interface 104 can be stored in tangible storage device 410. Both, the operating system and the modules existing in controller 108 of system 100 are executed by processor 402 via one or more respective RAMs 404 (which typically include cache memory).

Examples of storage devices 410 include semiconductor storage devices such as ROM 406, EPROM, flash memory or any other computer-readable tangible storage device 410 that can store a computer program and digital information. Computing device also includes R/W drive or interface 414 to read from and write to one or more portable computer-readable tangible storage devices 428 such as a CD-ROM, DVD, memory stick or semiconductor storage device. Further, network adapters or interfaces 412 such as a TCP/IP adapter cards, wireless wi-fi interface cards, or 3G or 4G wireless interface cards or other wired or wireless communication links are also included in computing device 400. In one embodiment, the modules existing in controller 102 can be downloaded from an external computer via a network (for example, the Internet, a local area network or other, wide area network) and network adapter or interface 412. Computing device 400 further includes device drivers 416 to interface with input and output devices. The input and output devices can include a computer display monitor 418, a keyboard 424, a keypad, a touch screen, a computer mouse 426, and/or some other suitable input device.

While specific language has been used to describe the disclosure, any limitations arising on account of the same are not intended. As would be apparent to a person skilled in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A system for rendering a Progressive Web Application (PWA) content on a home screen of a mobile device, the system comprising:
an interface configured for enabling creation of one or more PWA;
a remote server configured for hosting the created one or more PWA; and
a browser based configuring application residing on the mobile device, wherein the mobile device comprises a processor with a memory, wherein the processor is configured for performing the steps of:
providing a browser interface, to a user for accessing one or more PWAs;
receiving instructions from the user of the mobile device, to configure a selected PWA on the home screen of the mobile device;
communicating one or more parameters associated with the selected PWA to an application programming interface of the mobile device for configuring the selected PWA on the home screen of the mobile device; and
rendering the content of the selected PWA upon receiving instructions from the user of the mobile device on the selected PWA.

2. The system as claimed in claim 1, wherein the browser based configuring application comprises a configuration component for rendering the content of the one or more PWA on the home screen of the mobile device.

3. The system as claimed in claim 1, wherein the one or more parameters associated with the PWA comprises an icon, a name and a Uniform Resource Locator (URL) of the selected PWA.

4. The system as claimed in claim 1, wherein the PWA is configured on the home screen of the mobile device with a single instruction received from the user of the mobile device.

5. The system as claimed in claim 1, wherein the PWA comprises a function to an application programming interface (API) of the operating system of the mobile device or an external REST API or both.

6. The system as claimed in claim 1, wherein the browser based configuring application includes a function from an application programming interface of an operating system of the mobile device.

7. The system as claimed in claim 1, wherein the remote server comprises a database configured to store the created PWA and a search interface for accessing and configuring PWA on the home screen of the mobile device.

8. The system as claimed in claim 1, wherein the remote server provides an interface for purchasing one or more PWAs using various payment modes.

9. The system as claimed in claim 8, wherein the remote server creates a smart contract and broadcasts an event of creation of smart contract to one or more connected devices for verifying the purchase of one or more PWAs.

10. The system as claimed in claim 1, wherein the browser based configuring application is configured for automatic versioning of the PWA on the home screen of the mobile device.

11. The system as claimed in claim 2, wherein the configuration component is configured to customize the content of the PWA or the browser interface of the mobile device or both, for rendering the content of the PWA on the mobile device.

12. A method for rendering a Progressive Web Application (PWA) content on a home screen of a mobile device, the method comprising:
creating, one or more PWA using an interface;
hosting the created one or more PWA on a remote server;
providing a browser interface, to a user for accessing one or more PWAs;
receiving instructions from the user of the mobile device, to configure the PWA on the home screen of the mobile device;
communicating one or more parameters associated with the PWA to an application programming interface for configuring the PWA on the home screen of the mobile device; and
rendering the content of the PWA upon receiving instructions from the user of the mobile device on the PWA.

13. The method as claimed in claim 12, wherein the one or more parameters associated with the PWA comprises an icon, name and Uniform Resource Locator (URL) of the rendered PWA.

14. The method as claimed in claim 12, wherein the PWA is configured on the home screen of the mobile device with a single instruction received from the user of the mobile device.
